(19) United States
(12) Patent Application Publication
(10) Pub. No.: US 2018/0262030 A1
(43) Pub. Date: Sep. 13, 2018

(54) RECHARGING SYSTEM FOR PORTABLE ELECTRONIC DEVICES

(71) Applicant: Mark Zadvinskis, Saline, MI (US)

(72) Inventor: Mark Zadvinskis, Saline, MI (US)

(21) Appl. No.: 15/913,411

(22) Filed: Mar. 6, 2018

Related U.S. Application Data
(60) Provisional application No. 62/468,131, filed on Mar. 7, 2017.

(51) Int. Cl. H02J 7/00; H02J 7/02

(52) U.S. Cl. CPC H02J 7/0044; H02J 7/0021; H02J 7/025

(57) ABSTRACT

A system and method allows laptop computers and other portable electronic devices to be recharged in a docking station without having to manipulate a power cord when the device is stowed. The docking station that provides power to a set of electrical contacts or an inductive charger. The portable electronic device, or a case or shell for the device mates with the contacts or inductive charger and routes power to the power input port of the device or directly to the battery within the device. The invention anticipates the use of laptop, tablet and pad computers, smartphones, video/music players, or any portable electronic device that allows for charging in a dock, locker or mobile cart. The docking station may be stationary or mobile, and may include one or multiple bays for multiple devices.

### REFERENCE TO RELATED APPLICATIONS

This application claims the benefit and priority of U.S. Provisional Patent Application Ser. No. 62/468,131, filed Mar. 7, 2017, the entire content of which is incorporated herein by reference.

### FIELD OF THE INVENTION

This invention relates generally to systems and methods for recharging portable electronic devices and, in particular embodiments, to systems and methods for recharging such devices while enclosed in cases.

### BACKGROUND OF THE INVENTION

It is becoming increasingly popular to provide schoolchildren with laptop computers, which they obtain from a cart or locker in the classroom. One problem is that students, particularly younger children, can drop the computer while removing or returning the device from and to its storage compartment, thereby costing the school considerable funds. Problems may also arise in the wiring associated with plugging and unplugging the recharger, resulting in dead batteries or poor contacts.

The need remains, therefore, for a system which is relatively straightforward in terms of charging, while, at the same time, protects expensive devices such as laptop computers and other portable electronic devices.

### SUMMARY OF THE INVENTION

This invention improves upon existing recharging systems by allowing for laptop computers and other portable electronic devices to be recharged in a docking station without having to manipulate a power cord when the device is stowed. The invention anticipates both electric contacts and wireless arrangements.

The system involves two aspects: (1), a docking station that provides power to a set of electrical contacts or an inductive charger; and (2) a portable electronic device, or case for such a device, that mates with the contacts or inductive charger and routes power to the power input port of the device. This part of the system may be a computer bag or case, a snap-on protective shell or and adhesive plate directly applied or built into the to the device. Further, while the term “laptop” is used frequently herein, this term should be taken to include a tablet computer, pad computer, smartphone, video/music players, or any portable electronic device that allows for charging in a dock, locker or mobile cart.

A dock/charging station accepts the universal charging plate on the laptop case, protective shell, or pad applied or built into the device. The term “station” as used herein should be taken to include a system integrated into a locker, mobile or stationary storage cart with one or more slots or compartments, a desk, a bedside dock, and so forth. While the connection may be inductive (as described in further detail herein), the preferred embodiment is based on a direct, physical connection via electrical contacts, allowing for faster charging than induction, which may be important in educational environments. The charging station may provide power through its own source (i.e., transformer/voltage regulator), or may alternatively use conventional laptop adapters plugged into the receiving plate system.

To ensure a reliable connection, the system incorporates a known, predetermined location for both charging plates to meet and make solid contact. Various mechanisms, including gravity and magnetic contacts may be used to further improve a reliable electrical connection. Unless built into the device itself, a short cord extends from the plate to the power plug on the device. In a carrying case embodiment, this cord would be on the inside of the case and would be long enough to reach all necessary plug-in locations around the perimeter of the laptop. The invention may utilize any number of connection types, including USB, and so forth.

An adaptor cable may be provided between the device and the electrical contacts so that the same or similar case may be used with different model devices from different manufacturers. For greater ‘universality,’ a voltage-changing adaptor cable may be provided within the case between the device and the electrical contacts or at the base itself.

To reduce shorting, one or more of the electrical contacts may protrude from the case, or one or more of the electrical contacts may be recessed. One or more of the electrical contacts may be adapted to magnetically engage with a corresponding set of electrical contacts, and a light may be provided on the case or the docking station to indicating that electrical current is flowing to the device through the case.

Such a docking bay may take the form of a charging stand, a cart with one or more slots or compartments, or a locker with a door and a storage compartment. The system may further include an externally accessible compartment having an opening within the case to the device, and a power adapter having a plug-in cord within the compartment, enabling the cord to be connected to a source of power with the device enclosed within the case.

### BRIEF DESCRIPTION OF THE DRAWINGS

FIG. 1 illustrates a case for a portable electronic device such as a laptop computer with a set of electrical contacts and the back of the case;

FIG. 2 is a drawing of an alternative case for a portable electronic device such as a laptop computer with a set of electrical contacts on a side of the case;

FIG. 3 shows an embodiment of the invention wherein a set of electrical contacts are applied or built into the case for a portable electronic device such as a laptop computer;

FIG. 4 depicts a storage bay for a plurality of portable electronic devices, and wherein the devices are inserted in a horizontal fashion; and

FIG. 5 depicts a storage bay for a plurality of portable electronic devices, wherein the devices are inserted in a vertical fashion, and wherein the charging plate in this case is on the side of the device.

### DETAILED DESCRIPTION OF THE PREFERRED EMBODIMENTS

Broadly, this invention resides in portable electronic devices, cases and corresponding storage facilities that enable the device to be recharged without manipulating power cords, thereby protecting the device during periods when it is not in use. The invention is applicable to all types of portable electronic devices, including laptop, notebook and palm-top computers, as well as telecommunications devices, video players and music players.

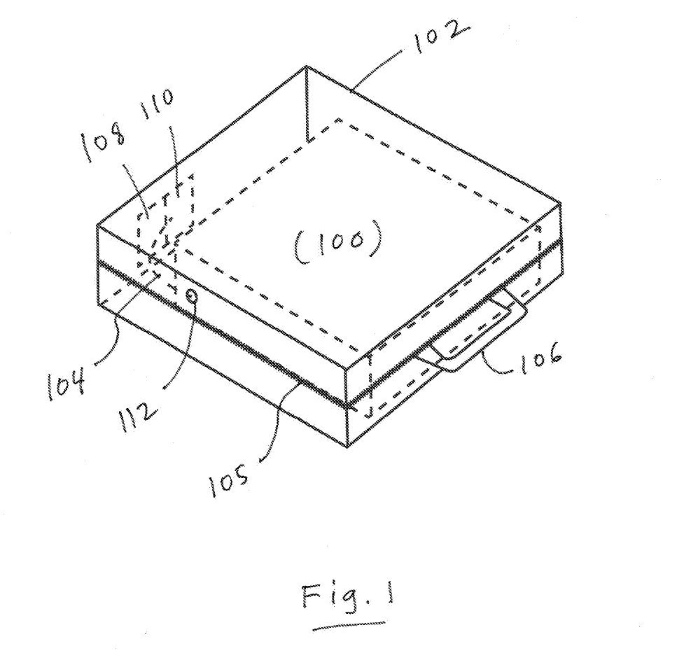

A preferred embodiment is shown in FIG. 1. The case, 102, which may be of any soft or hard design, includes contacts 108, 110 that interconnect to a device 100 by way of a power cord shown in broken-line form at 104, through an appropriate electrical interconnection 112 such as a power or USB port. In the preferred embodiment two or more such contacts are provided, depending upon the make/model of the enclosed device, though an embodiment with a single contact is possible if at least a portion of the outside surface of the case is sufficiently electrically conductive to act as ground or a positive/negative electrode. The case typically includes some sort of closure such as zipper 105, and an optional handle 106, in this embodiment located on an edge opposite to the contacts 108, 110.

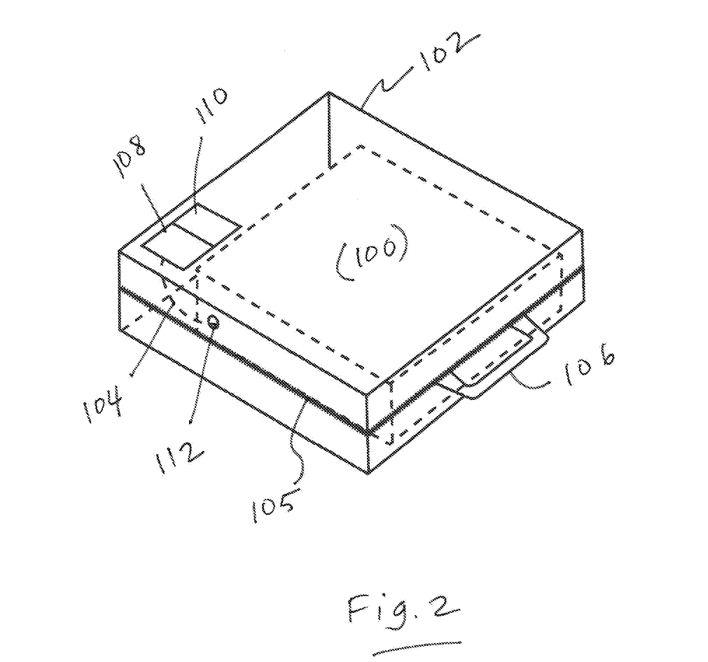

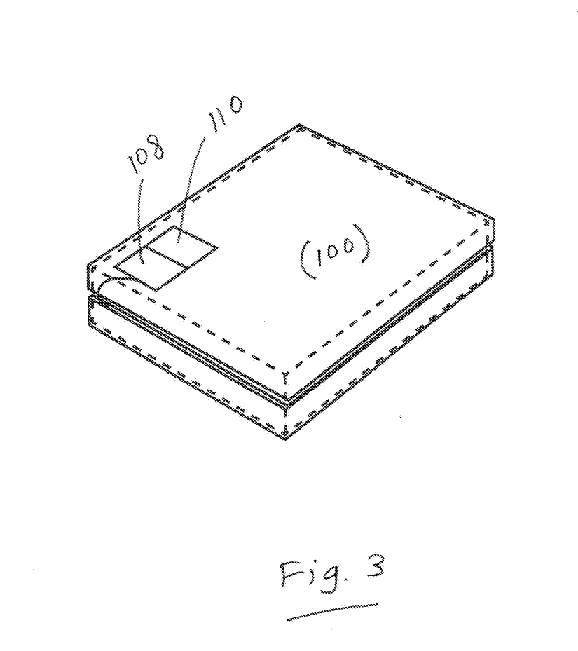

FIG. 2 is a drawing of an alternative case for a portable electronic device such as a laptop computer, wherein the electrical contacts 108, 110 are on a side of the case. FIG. 3 shows an embodiment of the invention wherein a set of electrical contacts 108, 110 are applied to, or built into, the case for a portable electronic device such as a laptop computer. While reference is made to “electrical contacts,” it will be appreciated that in inductive charging embodiments the electrical contacts would be replaced with an induction receiver adapted to mate with an inductive transmitter disposed in the docking part of the system.

The contacts 108, 110 (or inductive charging plate, as the case may be), are in electrical communication with interconnect 112 suited to a particular type of portable electronic device. This allows the same case to be manufactured with the same charging panel, with appropriate connectors being used for a particular make and model. For example, a Dell notebook computer may have two contacts with wiring going to a concentric plug suited for that manufacturer, whereas an Apple computer may use three contacts with an interconnect going to a square-type connector on the computer. The invention is not limited in this regard.

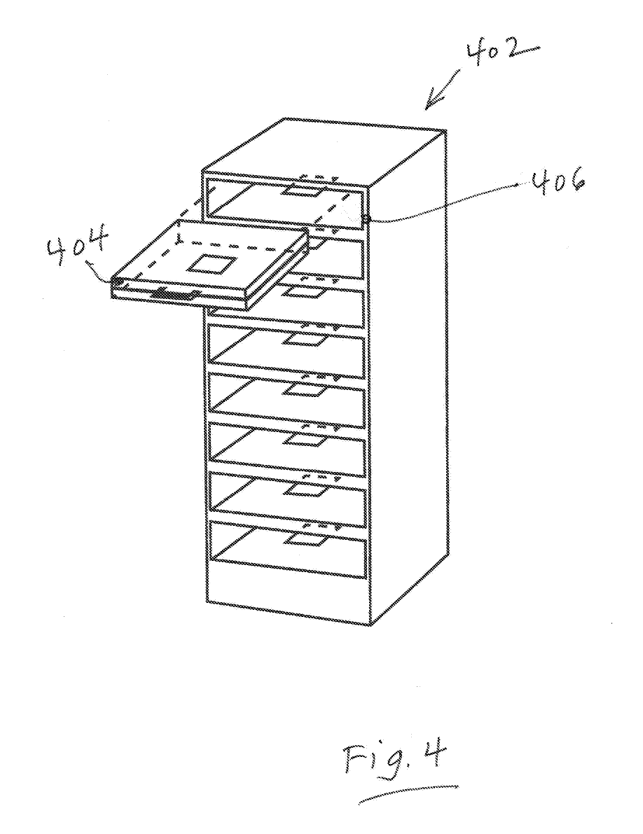

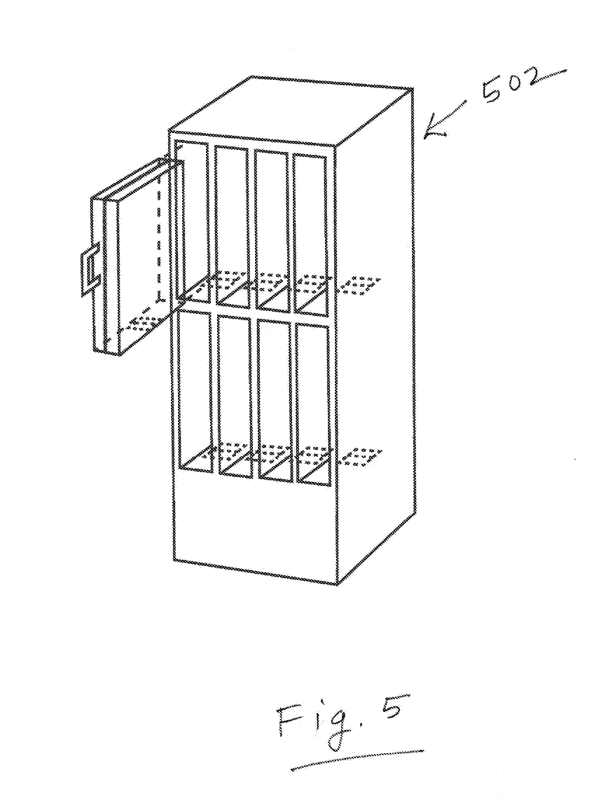

Given the in-case recharging capability just described, the case may be used in conjunction with various docking stations, including the storage units shown in FIGS. 4, 5. FIG. 4 depicts a storage bay 402 for a plurality of portable electronic devices, and wherein the devices are inserted in a “horizontal” fashion, and FIG. 5 depicts a storage bay 502 for a plurality of portable electronic devices, wherein the devices are inserted in a “vertical” arrangement, and wherein the charging plate in this case is on the side of the device.

Regardless of the embodiment, the contacts at the bottom of each receptacle are configured for corresponding contact with the contacts on the case. Once contact is made, an optional indicator light 404 on the case itself, or on the storage cart at 406, may illuminate to show that proper contact has been made. Although the compartments are shown as being horizontal or vertical, such slots may be may be angled. Further, while stationary docking stations are shown in FIGS. 4, 5 it should be understood that mobile carts with wheels/casters may also be provided.

For reasons of safety, and/or to ensure reliable contact, the contacts on the case, or the contacts on the cart or docking station may be recessed or projecting. That is, some or all of the contacts on the case may protrude and make contact with recessed contacts on the cart or docking station. Alternatively, some or all of the contacts on the cart or docking station may protrude, to be received by recessed contacts on the case. Alternatively, a mixture of recessed and protruding contacts may be used, to help avoid metal objects from shorting out the contacts on the cart/docking station or inventive case.

In the event that gravity alone is not relied upon to ensure reliable contact, the contacts on the cart/docking station and/or case may be spring-loaded or magnetic. In the case of magnetic contacts, the magnets may also be disposed on springs, allowing the cart/docking station or computer case contacts to “find one another” when the case is received in the article for recharging. The use of magnetic contacts would also facilitate somewhat of a “tactile” sound or feel, providing a user with a more positive indication that recharging was in progress.

1. A recharging system for a portable electronic device including a rechargeable battery, the system comprising:
a power receiving charging plate associated with the portable electronic device, and wherein the charging plate moves with the device;
an electrical cord interconnecting the charging plate to the rechargeable battery disposed in the portable electronic device;
a docking station configured to receive the portable electronic device, and wherein the docking station includes a power delivering charging plate that cooperates with power receiving charging plate of the portable electronic device.

2. The system of claim 1, wherein the power receiving charging plate is on or in the portable electronic device.

3. The system of claim 1, wherein the power receiving charging plate is on or in a protective case or shell for the portable electronic device, and
further including an electrical cable interconnecting the power receiving charging plate to a port of the portable electronic device in communication with the rechargeable battery of the device.

4. The system of claim 1, wherein the power receiving and power delivering charging plates comprise a plurality of contacts facilitating direct electrical connection.

5. The system of claim 1, wherein the power receiving and power delivering charging plates are inductive, thereby eliminating the need for a direct electrical connection.

6. The system of claim 1, wherein the device is a laptop computer, tablet computer, pad computer, smartphone, or video/music player.

7. The system of claim 1, wherein the plates, contact, or both the plates and contacts are adapted to magnetically engage to assist in the transfer of electrical power.

8. The system of claim 1, further including a light indicating that electrical current is flowing to the device.

9. The system of claim 1, wherein the docking station comprises a cart with a plurality of storage compartments, each compartment being configured to receive a portable electronic device, and wherein each compartment is equipped with a separate power delivering charging plate.

10. A recharging system for portable electronic devices, each including a rechargeable battery, the system comprising:
a carrying case for each portable electronic device, each case having an electrical conductor interconnecting a charging port on the portable electronic device to a charging plate;
a cart with a plurality of storage compartments, each storage compartment being configured to receive a respective one of the portable electronic devices;
a power distribution network including an input for receiving power from a source of power and cabling for delivering the power to an electrically conductive contact disposed in each one of the storage compartments;
wherein the electrically conductive contact in each compartment is physically configured to make electrical contact with the charging plate associated with case when the case is received by one of the compartments.

11. The system of claim 10, including a plurality of charging plates associated with each case and a plurality of contacts associated with each one of the compartments.

12. The system of claim 10, wherein the device is a laptop computer, tablet computer, pad computer, smartphone, or video/music player.

13. The system of claim 10, wherein the plates, contacts, or both the plates and contacts are adapted to magnetically engage to assist in the transfer of electrical power from the power distribution network to each device.

14. The system of claim 10, further including a light on the cart indicating that electrical current is flowing to a device.
